(19) United States
(12) Patent Application Publication
(10) Pub. No.: US 2015/0193232 A1
(43) Pub. Date: Jul. 9, 2015

(54) SYSTEMS AND METHODS FOR PROCESSING SENSOR DATA WITH A STATE MACHINE

(71) Applicant: InvenSense, Incorporated, San Jose, CA (US)

(72) Inventor: William Kerry Keal, Santa Clara, CA (US)

(73) Assignee: InvenSense, Incorporated, San Jose, CA (US)

(21) Appl. No.: 14/151,464

(22) Filed: Jan. 9, 2014

(51) Int. Cl. G06F 9/30; G01B 21/00

(52) U.S. Cl. CPC G06F 9/30003; G01B 21/00

(57) ABSTRACT

A state machine may be implemented in hardware by representing each state with one operational code (opcode) such that each opcode may be read from memory in sequential order. The state machine includes a plurality of states linked by at least one transition triggered by data input. The data input may be motion sensor data such that the state machine is configured to recognize a pattern of motion corresponding to a gesture or an activity.

### FIELD OF THE PRESENT DISCLOSURE

This disclosure generally relates to implementation of state machines in hardware and software.

### BACKGROUND

The development of microelectromechanical systems (MEMS) has enabled the incorporation of a wide variety of sensors into mobile devices, such as cell phones, laptops, tablets, gaming devices and other portable, electronic devices. Non-limiting examples of sensors include motion or environmental sensors, such as an accelerometer, a gyroscope, a magnetometer, a pressure sensor, a microphone, a proximity sensor, an ambient light sensor, an infrared sensor, and the like. Further, sensor fusion processing may be performed to combine the data from a plurality of sensors to provide an improved characterization of the device's motion or orientation.

A wide variety of applications have been developed to utilize the availability of such sensor data. For example, gesture recognition or orientation detection of a device equipped with sensors allows a user to input commands or data by moving the device or by positioning the device in a predetermined orientation. Any numbers of implementations exist, including allowing a user to select particular device functions by simply moving, shaking, or tapping the device has resulted in such functionality can include motion gesture recognition implemented on motion sensing devices to allow a user to input commands or data by moving the device or otherwise cause the device sense the user's motion. For example, gesture recognition allows a user to easily select particular device functions by simply moving, shaking, or tapping the device. In another aspect, sensor data may be employed to classify an activity in which the user of the device may be engaged. As will be appreciated, the behavior of the device may be adjusted in any suitable manner depending on the type of activity recognized, such as by counting calories when the user is exercising or by disabling texting ability when the user is driving.

Therefore, the increased availability of sensor data in mobile devices provides numerous opportunities for extending their capabilities. In light of these possibilities, it would be desirable to provide systems and methods for processing such data to generate outputs that facilitate operation of the device. Further, it would be desirable to adapt these techniques for use in mobile devices that may be subject to power and computational constraints. Accordingly, this disclosure is directed to systems and methods for implementing a state machine at a hardware and software level wherein sensor data may be used to trigger transitions between states. While the following discussion is in the context of MEMS sensors as used in portable devices, one of skill in the art will recognize that these techniques may be employed to any suitable sensor application as desired.

### SUMMARY

As will be described in detail below, this disclosure include a device which may include at least one sensor outputting data coupled to CMOS hardware and a processor implemented in the CMOS hardware. The processor may be configured as a state machine including a plurality of states linked by at least one transition triggered by data input and each state is represented by one or more opcodes and the processor reads each opcode from memory in a sequential order. Each opcode may include a state variable and may be configured to compare the state variable with a first stored value and perform an action based on the comparison.

In one aspect, the action may include adjusting a counter value.

In another aspect, the action may include comparing a data input with a second stored value and changing the state variable based on the comparison of the data input with the second stored value. Further, the data input may be output from the sensor. Additionally, the data input may be processed data output from the sensor.

In yet another aspect, the action may include changing a value of a flag. As desired, the value of the flag may indicate whether to execute at least one additional opcode.

In one embodiment, the state machine may be configured to recognize a pattern of motion. The pattern of motion may corresponds to tapping the device, shaking the device, walking with the device, running with the device, biking with the device, swimming with the device, exercising in-place with the device, rowing with the device, driving with the device, holding the device, keeping the device motionless for a period of time and moving the device to a position adjacent a user's ear.

In one aspect, the sensor may be at least one of an accelerometer, a gyroscope and a magnetometer.

This disclosure also includes recognizing a pattern using a device by providing a device having a processor implemented in CMOS and a sensor outputting data and implementing a state machine with the processor, such that the state machine includes a plurality of states linked by at least one transition triggered by data input, each state may be represented by one opcode and reading each opcode from memory with the processor in a sequential order.

In one aspect, the method may also involve processing at least one opcode that includes a state variable so that processing the at least one opcode may include comparing the state variable with a first stored value and changing the state variable based on the comparison.

The method may include processing at least one opcode, wherein the at least one opcode includes a state variable and processing the at least one opcode compares the state variable with a first stored value and performs an action based on the comparison.

In one aspect, performing the action may include adjusting a counter value.

In another aspect, performing the action may include comparing a data input with a second stored value and changing the state variable based on the comparison of the data input with the second stored value.

The data input may be output from the sensor. Additionally, the data input may be processed before being input.

In yet another aspect, performing the action may include changing a value of a flag. As desired, the method may also include executing at least one additional opcode based on the value of the flag.

In one embodiment, the state machine may be configured to recognize a pattern of motion. The pattern of motion may be tapping the device, shaking the device, walking with the device, running with the device, biking with the device, swimming with the device, exercising in-place with the device, rowing with the device, driving with the device, holding the device, keeping the device motionless for a period of time or moving the device to a position adjacent a user's ear.

In one embodiment, the sensor may be at least one motion sensor including an accelerometer, a gyroscope and a magnetometer.

### BRIEF DESCRIPTION OF THE DRAWINGS

FIG. 1 is a block diagram of a device employing a state machine in accordance with an embodiment.

FIG. 2 depicts a state machine for processing sensor data in accordance with an embodiment.

FIG. 3 depicts a portion of C programming code corresponding to the state machine of FIG. 2.

FIG. 4 depicts a portion of assembly code corresponding to the state machine of FIG. 2.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

This disclosure generally relates to implementing a state machine in hardware by representing each state with one operational code (opcode) such that each opcode may be read from memory in sequential order. As will be described below, organizing the machine language instructions to be read in sequential order avoids the use of conventional programming constructs that involve out of order operations, such as jumps, branches, loops and the like. In turn, the sequential configuration of the instructions may readily be implemented in hardware to provide reduced computational requirements, low power consumption and a relatively small memory footprint. To that end, the following description is provided to enable one of ordinary skill in the art to make and use the techniques of this disclosure. Various modifications to the described embodiments and the generic principles and features described herein will be readily apparent to those skilled in the art. Thus, the present disclosure is not intended to be limited to the embodiments shown, but is to be accorded the widest scope consistent with the principles and features described herein.

In the described embodiments, a chip is defined to include at least one substrate typically formed from a semiconductor material. A single chip may be formed from multiple substrates, where the substrates are mechanically bonded to preserve the functionality. Multiple chip includes at least 2 substrates, wherein the 2 substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS substrate provides mechanical support for the MEMS structure. The MEMS structural layer is attached to the MEMS substrate. The MEMS substrate is also referred to as handle substrate or handle wafer. In some embodiments, the handle substrate serves as a cap to the MEMS structure. In the described embodiments, an electronic device incorporating a sensor may employ a motion tracking module also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. In the described embodiments, a MPU may include processors, memory, control logic and sensors among structures.

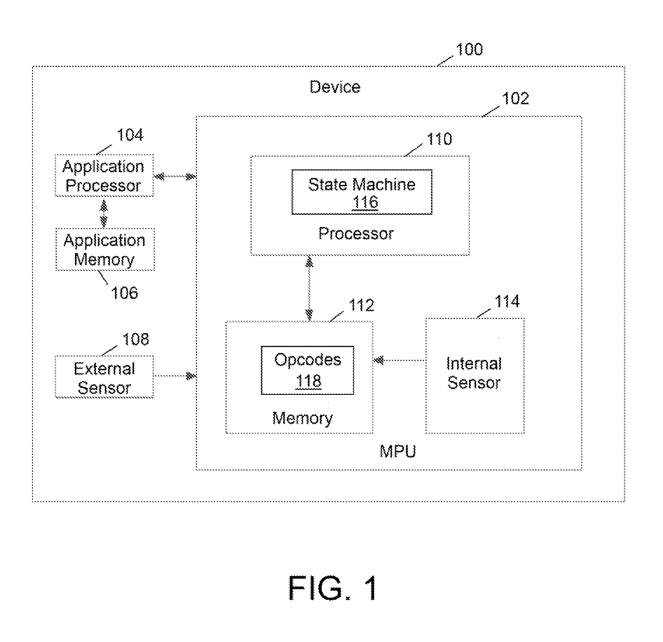

Details regarding one embodiment of an electronic device 100 including features of this disclosure are depicted as high level schematic blocks in FIG. 1. As shown, device 100 includes MPU 102, application processor 104, application memory 106, and external sensor 108. Application processor 104 may be configured to perform the various computations and operations involved with the general function of device 100. Application processor 104 may be coupled to MPU 102 through any suitable bus or interfaces, such as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent. Application memory 106 may include programs, drivers or other data that utilize information provided by MPU 102. Exemplary details regarding suitable configurations of application processor 104 and MPU 102 may be found in co-pending, commonly owned U.S. patent application Ser. No. 12/106,921, filed Apr. 21, 2008, which is hereby incorporated by reference in its entirety.

In this embodiment, MPU 102 is shown to include sensor processor 110, memory 112 and internal sensor 114. Memory 112 may store algorithms, routines or other instructions for processing data output by sensor 114 or sensor 108 as well as raw data and motion data. In particular, sensor processor 110 may include a state machine 116 and may read opcodes 118 representing each state that are stored in memory 112. In other embodiments, state machine 116 may be implemented in a separate processor and/or opcodes 118 may be stored in a different location.

As such, state machine 116 may be implemented in hardware, such as in a construction of Boolean logic gates configured to perform the computational operations corresponding to opcodes 118. In one aspect, state machine 116 may be implemented using complementary metal oxide semiconductors (CMOS) using techniques known to those of skill in the art.

Internal sensor 114 may include one or more sensors, such as accelerometers, gyroscopes, magnetometers, pressure sensors, microphones and other sensors. Likewise, external sensor 108 may include one or more sensors, such as accelerometers, gyroscopes, magnetometers, pressure sensors, microphones, proximity, and ambient light sensors, and temperature sensors among others sensors.

In some embodiments, the sensor processor 110 and MPU 102 are formed on different substrates and in other embodiments; they reside on the same substrate. In yet other embodiments, a sensor fusion algorithm that is employed in calculating orientation of device is performed externally to the sensor processor 110 and MPU 102, such as by application processor 104. In still other embodiments, the sensor fusion is performed by MPU 110. More generally, device 100 incorporates MPU 102 as well as application processor 104 and application memory 106 in this embodiment. However, application processor 104 and application memory 106 may be provided on a separate device and may communicate with MPU 102 using any suitable wireless or wired bus or interface technology, including WiFi®, BLUETOOTH®, ZigBee®, ANT, peripheral component interconnect express (PCIe) bus, a Inter-Integrated Circuit (I2C) bus, a universal serial bus (USB), a universal asynchronous receiver/transmitter (UART) serial bus, a suitable advanced microcontroller bus architecture (AMBA) interface, a serial digital input output (SDIO) bus and the like.

As indicated above, in this embodiment, sensor processor 110 includes state machine 116, wherein each state is represented by an opcode 118 stored in memory 112. Each opcode may be a binary value that maps to operation that may be performed by sensor processor 110 according to its particular instruction set architecture. Each opcode may also identify variables or other operands. As desired, variables may be stored in registers or may be referenced by pointers. Accordingly, each opcode may include a state variable that may be compared to a value in order to identify the current condition of state machine 116, such that the opcode causes processor 110 to perform an action based on that comparison. For example, the state variable may be compared to a value used to identify current state that is stored in the opcode or may be compared to a value in a register or referenced by a pointer. Suitable actions may include performing further comparisons, changing variables, setting flags or implementing counters. The following non-limiting examples help illustrate suitable opcodes that may be used by state machine 116.

In a first example, logic for transitions between states may be effected by a trigger resulting from a further comparison using an opcode having the binary format:
0000 0000 0000 00CC DDEE AAAA AABB BBBB
   CC, DD and EE may identify which of the registers to be used for the operands, AAAAAA may be the state variable is compared to and BBBBBB may be the value assigned to the state variable depending on the comparison. In this example, the two bits making up CC, DD, EE may refer to registers designed R0, R1, R2 or R3. The number of bits used for a register is not limited to two bits in any of the examples. These registers may hold the variable values themselves or may point to a memory location. Thus for the first example, the logic would be:
if ((CC==AAAAAA) && (DD>EE)) then CC=BBBBBB

For state transition 206, where R0 is the state variable mode, R1 is gyroX and R2=200, then filing in example values for the registers and values may give:
if ((R0==0) && (R1>R2)) then R0=1

For further clarity, if R0 has a value of 0 designated with bits AAAAAA and R1 is greater than R2, change R0 to 1 or the bits designed with BBBBBB. In other embodiments other comparisons may be made but not limited to: less than, greater than, less than or equal, greater than or equal, equal, or not equal. In further other embodiments the comparison of the absolute value of one of the variables or registers may be made where the comparison may include but not limited to: less than, greater than, less than or equal, greater than or equal, equal, or not equal. The advantage of the opcode in this first example is the processor implementing the opcode avoids a branch statement. A branch statement often requires flushing a pipeline on the processor implementation or requires branch predicting to avoid flushing the pipeline which in turn requires more CMOS, power and memory to implement. For what would be a small branch, it is often advantageous to read the opcode and execute it. Often on implementation in hardware, only part of the opcode needs to implement. In the first example only the first comparison would need to be made and the second comparison would only need to be made if the first comparison was true.

In other embodiments, more than one action may take place. In the first example, the action was setting R0 to 1 when the conditions were met. Other actions may include but not limited to setting the register designed to, but not limited to, DD to zero or setting a condition flag.

In a second example, counter logic may be implemented as the action after the variable comparison by using an opcode having the format:
0000 0001 0000 00CC DD00 AAAA AA00 0000
   CC, DD may identify which of the registers to be used for the operands and AAAAAA may be the initial state variable value to compare to. In this example, the two bits making up CC and DD may refer to registers designed but not limited to R0, R1, R2 or R3. These registers may hold the values themselves or may point to a memory location. Thus the logic would be:
if (CC==AAAAAA) then DD++

The construct shown in the second example corresponds to element 222, described below, that increments a counter and could be implemented with:
If (R0==1) R3++
   Where R0 is the mode state variable and R3 is the counter variable. In other embodiments the comparison may be but not limited to: less than, greater than, less than or equal, greater than or equal, equal, or not equal. In further other embodiments the comparison of the absolute value of one of the variables or registers may be made where the comparison may include but not limited to: less than, greater than, less than or equal, greater than or equal, equal, or not equal. As with the first example, in the second and further examples, what would be a small branch, it is often advantageous to read the opcode and execute it. Often on implementation in hardware only part of the opcode needs to be implemented. In the second example only the first comparison would need to be made and the action of incrementing the register would only need to be made if the first comparison was true. The action of incrementing a variable may also be, but not limited to, decrementing a variable or changing the value of a flag or sending an interrupt.

Expanding upon the second example of setting a flag, a third example could be made using an opcode close to the one given in the second example.
0000 0000 0010 00CC 0000 AAAA AA00
   CC may identify which of the registers to be used for the operands and AAAAAA may be the initial state variable value to compare to. In this example, the two bits making up CC and DD may refer to registers designed but not limited to R0, R1, R2 or R3. These registers may hold the values themselves or may point to a memory location. Thus the logic would be:

if (CC == AAAAAA) then

Flag = 1;

Else

Flag = 0;

Filling in some example values and using registers, the logic could be:

if (R0 == 5) then

Flag = 1;

Else

Flag = 0;

Where R0 is the state variable and Flag is a hardware flag. The hardware flag could have many purposes depending upon implementation. One purpose could be but not limited to would be to indicate whether to execute following opcodes. The advantage of that would be to extend the idea of reading the opcode but not fully executing it may be more efficient than implementing a jump. Another purpose of the hardware flag could be to generate an interrupt. In other embodiments the comparison may be but not limited to: less than, greater than, less than or equal, greater than or equal, equal, or not equal. In further other embodiments the comparison of the absolute value of one of the variables or registers may be made where the comparison may include but not limited to: less than, greater than, less than or equal, greater than or equal, equal, or not equal. As with the first two examples what would normally be implemented as a small branch, it is often advantageous to read the opcode and partially or fully execute it. Often on implementation of the opcode in hardware only part of the opcode needs to executed. In the third example only the first comparison would need to be made and the action would only need to be made if the first comparison was true.

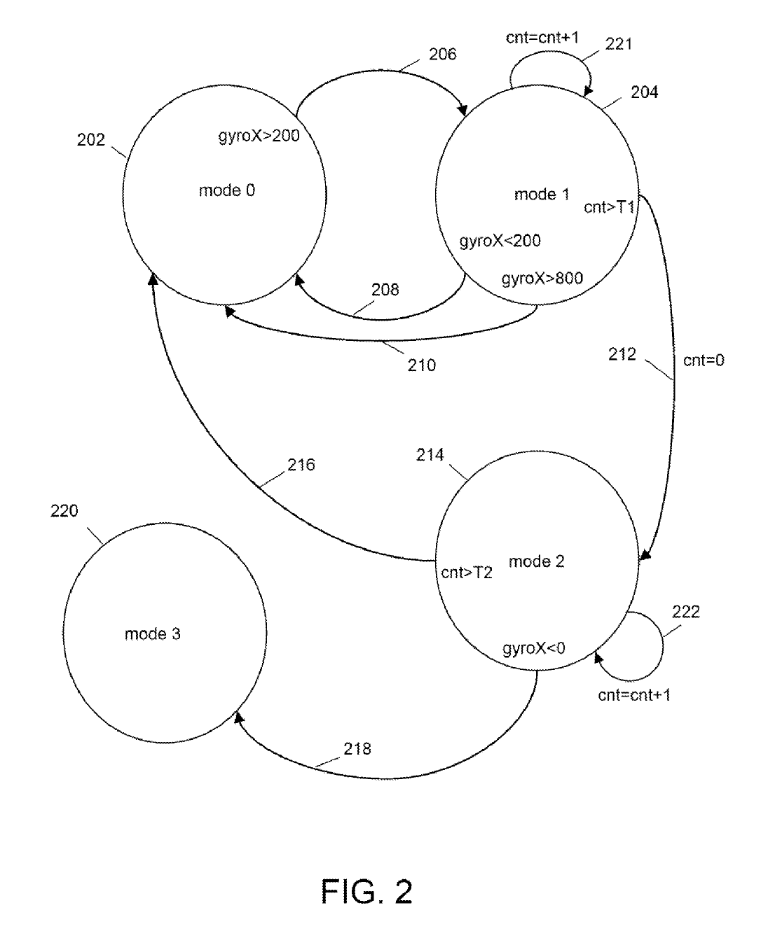

As a further illustration of the techniques of this disclosure, FIG. 2 depicts an example of state machine 116 configured to process output from internal sensor 114. In this embodiment, transitions between the states based on comparisons between the sensor data and a counter variable and suitable thresholds. However, as will be appreciated, the techniques of this disclosure may be applied to any operations that may be executed by processor 110 in response to a corresponding opcode any may include any available inputs. In FIG. 2, state machine 116 begins in a default state, mode 0 202, and transitions to mode 1 204 in response to trigger 206. In this embodiment, sensor 114 outputs, at the least, a rate of angular change along the X-axis, which may be stored as the variable gyroX. Correspondingly, trigger 206 may cause a transition to mode 1 204 when gyroX exceeds a first motion threshold. As shown, trigger 208 may cause a return to mode 0 202 if gyroX falls below the first motion threshold. Further, a second trigger, trigger 210 may also cause a reversion to mode 0 202 if gyro X exceeds a second motion threshold. While in mode 1 204, a counter may be initialized and incremented such that trigger 212 causes a transition to mode 2 214 when a first time threshold is exceeded. Upon entry to mode 2 214, the counter may be restarted. If the counter reaches a second time threshold, state machine 116 may return to mode 0 202. However, if gyroX falls below zero (or another suitable threshold), trigger 218 may cause a transition to mode 3 220. As desired, mode 3 220 may constitute successful recognition of a defined pattern of motion. As such, when state machine 116 arrives at the state corresponding to mode 3 220, device 100 may be configured to perform an action associated with the recognized pattern. Counters may be implemented as indicated by triggers 221 and 222.

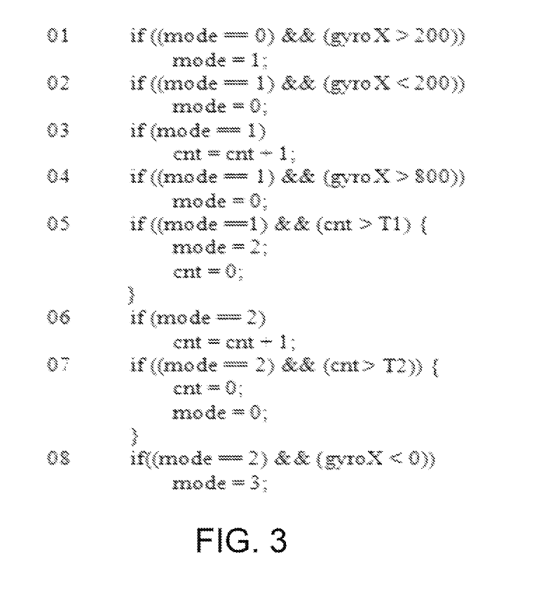

State machine 116 as reflected in FIG. 2 may be expressed in a suitable higher-level programming language as desired. For purposes of illustration, FIG. 3 illustrates code in the C programming language corresponding to state machine 116 as represented in FIG. 2. Instruction 01 compares the state variable mode to a stored value corresponding to default state, mode 0 (202 in FIG. 2). If mode is 0 and gyroX exceeds the first motion threshold (200 in this example), the state variable is set to 1, corresponding to trigger 206. Next, instruction 02 compares the state variable to another stored value, 1, to determine the current condition of state machine 116. If mode is 1 and gyroX is below the first motion threshold, the state variable is set to 0, corresponding to trigger 208. Instruction 03 also determines if mode is 1 and increments the counter if so. Instruction 04 likewise determines if mode is 1 and performs a further comparison of gyroX to the second motion threshold (800 in this example). If the second motion threshold is met, mode is set to 0, corresponding to trigger 210. Instruction 05 also determines if mode is 1 and performs a further comparison of the counter to a first time threshold (T1), and if met, sets mode to 2 corresponding to trigger 212. In practical terms, these instructions determine if device 100 is rotating in the X-axis at an intermediate rate, between the first and second motion thresholds for a period of time corresponding to the first time threshold. When each of these conditions is met, state machine 116 transitions to mode 2 214, resetting the counter and otherwise returns to mode 0 202.

Next, instruction 06 compares mode to a stored value 2 to determine if the remainder of the instruction is executed. If so, the counter is incremented again. Instruction 07 also applies if mode is 2 and determines whether a period of time corresponding to a second time threshold (T2) has elapsed. If so, the counter is reset and mode is set to 0, corresponding to trigger 216. Finally, instruction 08 determines if mode is 2 and performs a further comparison of gyroX and another stored value (0, or any other suitable threshold), setting mode to 3 if the condition is met which corresponds to trigger 218. Thus, the instructions are configured to determine if after device 100 is rotated on the X-axis in one direction, whether it is then rotated in the opposite direction within a given period of time.

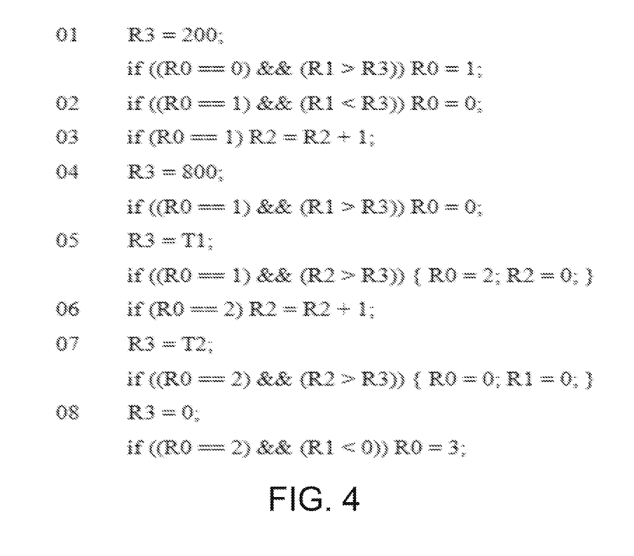

As known to those of skill in the art, higher-level programming code, such as that depicted in FIG. 3, may be compiled to produce a corresponding set of instructions in assembly language. FIG. 4 depicts a set of assembly language instructions corresponding to this exemplary embodiment of state machine 116. Assembly language is a lower-level programming language and corresponds closely to the machine language of opcodes 118. Final conversion from assembly language to machine language may be performed by an assembler, using techniques known in the art.

As an example, when going from From FIG. 3 to FIG. 4, mode is being replaced with R0, gyroX is being replaced with R1, cnt is being replaced with R2, Value 200, 800, 0, T1, T2 are all being replaced with R3. For this example, the Segments labeled 01 to 08 in FIG. 3 are equivalent to Segments 01 to 08 in FIG. 4. As a further illustration of the techniques of this disclosure, extending upon the opcodes defined above, additional opcodes may be defined as follows.

For logic:
if ((CC==AAAAAA) && (DD<EE)) then CC=BBBBBB
   implemented with
0000 0000 0000 10CC DDEE AAAA AABB BBBB

For logic
if ((CC==AAAAAA) && (DD>EE)) then CC=BBBBBB, DD=0;

Setting a register to a constant value maybe implemented with
0001 0000 00CC 0000 GGGG GGGG GGGG GGGG
   Where CC describes which register and the GGGG GGGG GGGG GGGG describes the 16-bit constant to set the register to.

The assembly code and binary patterns to implement Segment 01 in FIG. 4 may be:
0001 0000 0011 0000 0000 0000 1100 1000; R3=200 0000 0000 0000 0000 0111 0000 0000 0001; if ((R0==0) && (R1>R3)) R0=1;

Segment 02 may be:
0000 0000 0000 0100 0111 0000 0100 0000; if ((R0==1) && (R1<R3)) R0=0;

Segment 03 may be:
0000 0001 0000 0000 1000 0000 0100 0000; if (R0==1) R2=R2+1;

Segment 04 may be:
0001 0000 0011 0000 0000 0011 0010 0000; R3=800; 0000 0000 0000 0000 0111 0000 0100 0000; if ((R0==1) && (R1>R3)) R0=0;

Segment 05 may be:
0001 0000 0011 0000 ______ ______ ______ ______; R3=T1; Note, here T1 can be any 16-bit value as represented by the blanks.
0000 0000 0000 1000 1011 0000 0100 0010; if ((R0==1) && (R2>R3)){R0=2; R2=0;}

Segment 06 may be:
0000 0001 0000 0000 1000 0000 1000 0000; if (R0==2) R2=R2+1;

Segment 07 may be:
0001 0000 0011 0000 ______ ______ ______ ______; R3=T2; Note, here T2 can be any 16-bit value as represented by the blanks.
0000 0000 0000 1000 1011 0000 1000 0000; if ((R0==2) && (R2>R3)){R0=0; R1=0;}

Segment 08 may be:
0001 0000 0011 0000 0000 0000 0000 0000; R3=0;
0000 0000 0000 0100 0111 0000 0100 0011; if ((R0'2=2) && (R1<0)) R0=3;

Accordingly, the techniques of this disclosure the registers shown in the opcodes may be different in number than the four shown and may be registers that hold values or point to a memory location. An extension upon the idea is to have the register point to a section of memory that contains the data and to use less registers in the opcode itself, while still keeping the small number of opcodes and avoiding the use of a branch statement. The state machines derived from the opcodes disclosed are very good for implementing gestures and motion detections including detecting a user tapping on a device, detecting walking with the device, detecting running with the device, detecting going up or down stairs with the device, detecting biking with the device, detecting swimming with the device, detecting exercising in-place with the device, detecting shaking the device, detecting rowing with the device, detecting holding the device, detecting driving with the device, detecting keeping the device motionless, detecting a motion to hold the phone to the ear, detecting looking at a watch or shaking a watch, detecting a mouse that translates motion in three dimensions to two dimensions. The state machine and software derived from using these opcodes is both small in the amount of memory and low in amount of power needed.

Accordingly, the techniques of this disclosure may be applied to implement state machine 116 in processor 110 by representing each state with one opcode that is read from memory in sequential order. State machine 116 may process inputs from internal sensor 114, external sensor 108 or another other suitable source. Further, by processing sensor data, state machine 116 may be configured to identify patterns of motion or orientation in order to recognize a gesture performed with device 100 or to classify an activity in which the user of device 100 is engaged. Exemplary details regarding suitable techniques for gesture recognition are described in co-pending, commonly owned U.S. patent application Ser. No. 12/252,322, filed Oct. 15, 2008 and suitable techniques for activity classification are described in co-pending, commonly owned U.S. patent application Ser. No. 13/648,963, filed Oct. 10, 2012, both of which are hereby incorporated by reference in their entirety.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A device, comprising
at least one sensor outputting data, wherein the sensor is coupled to CMOS hardware; and
a processor implemented in the CMOS hardware, wherein the processor is a state machine including a plurality of states linked by at least one transition triggered by data input,
wherein each state is represented by one opcode and wherein the processor reads each opcode from memory in a sequential order.

2. The device of claim 1, wherein each opcode comprises a state variable and is configured to compare the state variable with a first stored value and perform an action based on the comparison.

3. The device of claim 2, wherein the action comprises adjusting a counter value.

4. The device of claim 2, wherein the action comprises comparing a data input with a second stored value and changing the state variable based on the comparison of the data input with the second stored value.

5. The device of claim 4, wherein the data input is output from the at least one sensor.

6. The device of claim 4, wherein the data input is processed data output from the at least one sensor.

7. The device of claim 2, wherein the action comprises changing a value of a flag.

8. The device of claim 7, wherein the value of the flag indicates whether to execute at least one additional opcode.

9. The device of claim 1, wherein the state machine is configured to recognize a pattern of motion.

10. The device of claim 9, wherein the pattern of motion corresponds to is at least one of the group consisting of tapping the device, shaking the device, walking with the device, running with the device, biking with the device, swimming with the device, exercising in-place with the device, rowing with the device, driving with the device, holding the device, keeping the device motionless for a period of time and moving the device to a position adjacent a user's ear

11. The device of claim 1, wherein the sensor comprises at least one motion sensor selected from the group consisting of an accelerometer, a gyroscope and a magnetometer.

12. A method for recognizing a pattern using a device, the method comprising:
providing a device having a processor implemented in CMOS and a sensor outputting data;
implementing a state machine with the processor, wherein the state machine includes a plurality of states linked by at least one transition triggered by data input, wherein each state is represented by one opcode; and
reading each opcode from memory with the processor in a sequential order.

13. The method of claim 1, further comprising processing at least one opcode, wherein the at least one opcode comprises a state variable and processing the at least one opcode compares the state variable with a first stored value and performs an action based on the comparison.

14. The method of claim 13, wherein performing the action comprises adjusting a counter value.

15. The method of claim 13, wherein performing the action comprises comparing a data input with a second stored value and changing the state variable based on the comparison of the data input with the second stored value.

16. The method of claim 15, wherein the data input is output from the at least one sensor.

17. The method of claim 15, further comprising processing data output from the at least one sensor and wherein the data input is the processed data.

18. The method of claim 13, wherein performing the action comprises changing a value of a flag.

19. The method of claim 18, further comprising executing at least one additional opcode based on the value of the flag.

20. The method of claim 12, wherein the state machine is configured to recognize a pattern of motion.

21. The method of claim 20, wherein the pattern of motion corresponds to at least one of the group consisting of tapping the device, shaking the device, walking with the device, running with the device, biking with the device, swimming with the device, exercising in-place with the device, rowing with the device, driving with the device, holding the device, keeping the device motionless for a period of time and moving the device to a position adjacent a user's ear.

22. The method of claim 12, wherein the sensor comprises at least one motion sensor selected from the group consisting of an accelerometer, a gyroscope and a magnetometer.
